(19) United States
(12) Patent Application Publication
(10) Pub. No.: US 2026/0358544 A1
(43) Pub. Date: Nov. 12, 2026

(54) OPTICAL ELEMENT AND OPTICAL DEVICE

(71) Applicant: Mitsubishi Electric Corporation, Tokyo (JP)

(72) Inventors: Natsuki TAKAGAWA, Tokyo (JP); Masayuki OMAKI, Tokyo (JP); Kenya NAKAI, Tokyo (JP); Hiromasa FUJII, Tokyo (JP)

(73) Assignee: Mitsubishi Electric Corporation, Tokyo (JP)

(21) Appl. No.: 19/131,979

(22) PCT Filed: Dec. 13, 2022
(86) PCT No.: PCT/JP2022/045754

§ 371 Date: May 22, 2025

(51) Int. Cl. G02B 5/30; G02B 1/00

(52) U.S. Cl. CPC G02B 5/3083; G02B 1/002

(57) ABSTRACT

An optical element includes a substrate, and a microstructure formed on a surface of the substrate and changing a phase of light. The microstructure includes a plurality of zones that impart a phase change of 0 to 2π to the light, each of the plurality of zones being divided into a plurality of regions. Each of the plurality of regions includes a plurality of structures. Each of the plurality of structures has a height in a direction perpendicular to the surface and a width in a direction parallel to the surface, and the plurality of structures are arranged at an interval as a center-to-center distance in the direction parallel to the surface. The interval between the plurality of structures arranged in one region of the plurality of regions is different from the interval between the plurality of structures arranged in another region of the plurality of regions.

### TECHNICAL FIELD

The present disclosure relates to an optical element having a function such as light collection, diffraction or the like, and an optical device including the optical element.

### BACKGROUND ART

In recent years, research has been progressed on metamaterials in which structures (also referred to as meta-atoms) smaller than the wavelength of electromagnetic waves such as light are arranged three-dimensionally. Metamaterials have attracted attention since they can realize physical properties that do not exist in nature.

In recent years, research has also been progressed on metasurfaces in which structures are arranged two-dimensionally. Metasurfaces are easier to manufacture than metamaterials having three-dimensional structure. For example, when light with a long wavelength such as terahertz light is used, the structures can be made relatively large, and it is easier to manufacture the metasurface.

Furthermore, as a lens utilizing a metasurface, a metalens in which structures are arranged two-dimensionally on a substrate is known. Unlike a curved lens, the metalens can be constructed in a flat and thin shape. Moreover, the metalens can be manufactured by a method such as a semiconductor process or nanoimprinting which are suitable for mass production.

The substrate for the metalens is made of, for example, SiO₂, Si, TiO₂, Ge or GaN. The substrate for the metalens may be made of a plurality of types of substrates which are stacked together. When the substrate is made of a material having a high refractive index, light is reflected due to the difference in refractive index at the interface between the structure and the substrate, or at the interface between the substrate and air.

For example, Patent Reference 1 discloses that, in regard to a lens in which pillars as cylindrical structures are arranged two-dimensionally on a substrate, the height and the diameter of the pillar vary for each region, and the upper ends (i.e., ends farthest from the substrate) of the pillars are aligned on the same plane.

By varying the height and the width of the pillar, the phase of light can be controlled.

### PRIOR ART REFERENCE

### Patent Reference

Patent Reference 1: Japanese Application Patent Publication No. 2021-99399 (see FIG. 4)

### SUMMARY OF THE INVENTION

### Problem to be Solved by the Invention

The diameter of each pillar is determined so as to be equal to or smaller than the wavelength of light and so as to suppress reflection of light at the interface. For example, for a terahertz wave having a wavelength of 125 μm, the diameter of the pillar is controlled to be in the range of 13 μm to 25 μm. On the other hand, for near-infrared light with a wavelength of 700 to 2500 nm, the diameter of the pillar needs to be controlled within the range of several tens of nm to several hundreds of nm. This requires an exposure apparatus with high resolution or the like, and the manufacturing cost increases.

The present disclosure is made in consideration of the above-described problem, and an object of the present disclosure is to reduce the manufacturing cost of an optical element.

### Means for Solving the Problem

An optical element of the present disclosure includes a substrate and a microstructure formed on a surface of the substrate and changing a phase of light. The microstructure includes a plurality of structures each having a height in a direction perpendicular to the surface and a width in a direction parallel to the surface, and arranged at an interval in the direction parallel to the surface. Among the height, the width and the interval of the structure, at least one including the interval differs depending on regions in the microstructure.

### Effect of the Invention

In the present disclosure, among the height, the width and the interval of the structure of the microstructure, at least one including the interval differs depending on the regions. Thus, the phase resolution can be increased even when, for example, an exposure apparatus with relatively low resolution is used. This makes it possible to reduce the manufacturing cost of the optical element.

### BRIEF DESCRIPTION OF THE DRAWINGS

FIG. 1 is a perspective view showing an optical element of a first embodiment;

FIG. 2 is a side view showing the optical element of the first embodiment;

FIG. 3 is a diagram illustrating a microstructure of the optical element of the first embodiment;

FIG. 4 is a diagram conceptually showing the microstructure of the first embodiment;

FIGS. 5(A) and 5(B) are schematic diagrams for explaining optical characteristics of the microstructure of the first embodiment;

FIG. 6(A) is a cross-sectional view showing the microstructure of the first embodiment, and FIG. 6(B) is a diagram showing a phase distribution of the microstructure of the first embodiment;

FIGS. 7(A) and 7(B) are respectively a cross-sectional view and a plan view showing the microstructure of the first embodiment;

FIGS. 8(A) to 8(H) are diagrams showing an example of a manufacturing method of the optical element of the first embodiment;

FIGS. 9(A) to 9(C) are graphs showing the relationship between a height of the structure and each of a transmittance and a phase when a diameter of the structure of the microstructure of the first embodiment is changed;

FIG. 10 is a graph showing the relationship between the height of the structure and each of the transmittance and the phase when the diameter of the structure of the microstructure of the first embodiment is made larger than that of FIG. 9(A);

FIG. 11 is a graph showing the relationship between the height of the structure and each of the transmittance and the phase when the pitch of the microstructure of the first embodiment is made larger than that of FIG. 9(A);

FIG. 12 is a graph showing the relationship between the height and the phase of the structure at which a transmittance of a specified value or higher is obtained in the microstructure of the first embodiment;

FIG. 13 shows the relationship between the ratio of the diameter to the pitch and each of the transmittance, the reflectance and the phase, when the height and the pitch of the structure are fixed and only the diameter of the structure is changed;

FIG. 14(A) is a graph showing the relationship between the structural parameter and each of the transmittance and the phase when only the height and the diameter of the structure are changed, FIG. 14(B) is a graph showing the relationship between the structural parameter and each of the transmittance and the phase when the height, the diameter, and the pitch of the structure are changed;

FIG. 15(A) is a cross-sectional view showing a microstructure of a second embodiment, and FIG. 15(B) is a diagram showing the phase distribution of the microstructure; and

FIGS. 16(A) and 16(B) are respectively a perspective view and a schematic view showing an example of an optical device to which the optical elements of the first and second embodiments are applicable.

### MODE FOR CARRYING OUT THE INVENTION

Hereinafter, optical elements of embodiments will be described with reference to the drawings. The following embodiments are merely examples, and may be modified as appropriate, or the embodiments may be combined as appropriate.

### First Embodiment

### (Entire Configuration of Optical Element)

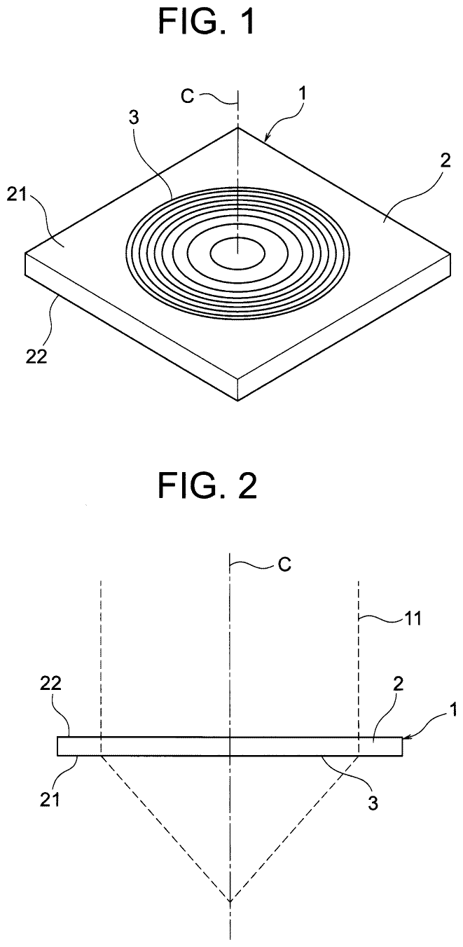

First, an optical element 1 of a first embodiment will be described. FIG. 1 is a perspective view showing the optical element 1 of the first embodiment. FIG. 2 is a side view showing the optical element 1.

The optical element 1 of the first embodiment is a lens that collects or collimates light. As shown in FIG. 2, the optical element 1 includes a microstructure 3, which is a concave-convex structure that changes the phase of light, formed on a surface 21 of a flat substrate 2. The microstructure 3 is also referred to as a metasurface. The optical element 1 is also referred to as a metalens.

The wavelength of light incident on the optical element 1 (incident light 11 shown in FIG. 2) is, for example, less than 30 μm. An example of the wavelength is 400 nm to 2000 nm. Light in this wavelength band includes visible light and infrared light.

The substrate 2 is made of a material that transmits light. For example, the substrate 2 is made of Si or TiO₂. The refractive index of the substrate 2 may be 2 or greater. It is preferable that the thickness of the substrate 2 is, for example, 0.3 mm or more and 2.0 mm or less. The substrate 2 has the surface 21 and a back surface 22, and the microstructure 3 is formed on the surface 21.

### (Configuration of Microstructure)

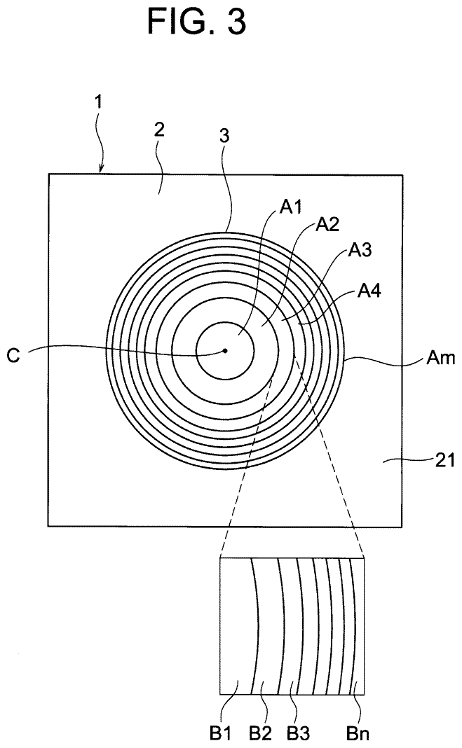

FIG. 3 is a plan view showing the microstructure 3 of the optical element 1. As shown in FIG. 3, the microstructure 3 has a plurality of concentric ring zones A1, A2, A3 . . . Am. “m” is an integer of 2 or more. An imaginary line passing through the center of the concentric ring zones A1 to Am and extending in the thickness direction of the substrate 2 is an optical axis C of the optical element 1. The ring zones A1, A2, A3 . . . Am are arranged in this order from the side closer to the optical axis C.

The width (that is, dimension in the radial direction about the optical axis C) of each of the ring zones A1 to Am decreases as a distance from the optical axis C increases. Each of the ring zones A1 to Am is a band in which the phase change given to light is 0 to 2π. The ring zones A1 to Am are collectively referred to as the ring zones A.

Each ring zone A has a plurality of concentric regions B1, B2, B3, . . . Bn centered on the optical axis C. “n” is an integer of 2 or more. The regions B1, B2, B3, . . . Bn are arranged in this order from the side closer to the optical axis C. The regions B1 to Bn are collectively referred to as the regions B.

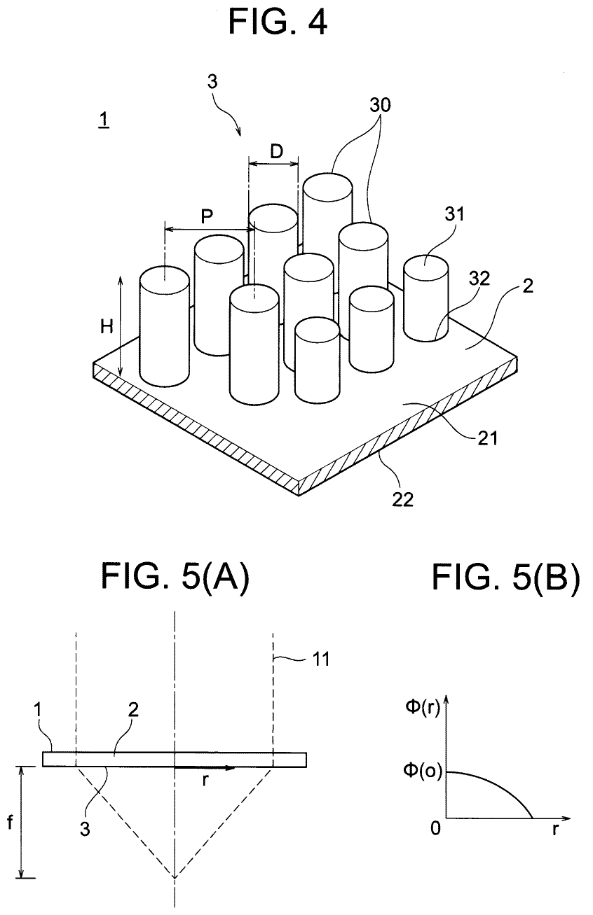

FIG. 4 is a perspective view conceptually showing an example of the configuration of the microstructure 3. The microstructure 3 is formed by arranging a plurality of structures 30 two-dimensionally. Each structure 30 has, for example, a cylindrical shape and is also referred to as a meta-atom or a pillar.

The structure 30 has a height H in a direction perpendicular to the surface 21 of the substrate 2 (i.e., the direction of the optical axis C), and has a width (more specifically, a diameter) D in a plane parallel to the surface 21 of the substrate 2. Further, a center-to-center distance between adjacent structures 30 in a plane parallel to the surface 21 of the substrate 2 is a pitch P.

At least one of the height H, the diameter D, and the pitch P of the structure 30 differ depending on the regions B1, B2, B3, . . . Bn (FIG. 3). In particular, among the height H, the diameter D, and the pitch P, at least one including the pitch P differs. Structures located in the same region (i.e., region B1) have the same height H, the same diameter D, and the same pitch P.

By varying the height H, the diameter D, and the pitch P of the structure 30 depending on the regions B in this way, it is possible to change the phase that the structure 30 impart to light. The shape of the structure 30 is not limited to a cylindrical shape, but may be, for example, a rectangular column shape. The diameter D of the structure 30 is also referred to as a width. The pitch P between the structures 30 is also referred to as an interval.

For example, by linearly changing the phase that the structures 30 impart to light, the light incident on the optical element 1 can be deflected (refracted). Further, by changing the phase that the structures 30 impart to light like a Fresnel lens, the structures 30 can exhibit a function to converge the incident light 11 or a function to collimate light that is incident thereon in a divergent state, as shown in FIG. 2. Further, the structures 30 can exhibit a function to split or reflect the incident light 11.

FIGS. 5(A) and 5(B) are schematic diagrams for explaining the phase distribution when the optical element 1 is configured as a condenser lens or a collimator lens. In FIGS. 5(A) and 5(B), a distance from a center of the optical element 1, i.e., the optical axis C, is denoted by r, and a phase at a position at a distance r from the center of the optical element 1 is denoted by Φ(r). A wavelength of light incident on the optical element 1 is denoted by λ, and a focal length of a lens which is the optical element 1 is denoted by f.

By changing the height H, the diameter D and the pitch P of the microstructure 3 for each of the regions B1 to Bn, a phase distribution satisfying the following Equation (1) can be obtained.

$$Φ ( r ) = Φ ( 0 ) - \frac{2 π}{λ} ( \sqrt{{r}^{2} + {f}^{2}} - f ) \qquad ( 1 )$$

Φ(0) is the phase at the center (r=0) of the optical element 1. Here, Φ(0)=2π, and the phase distribution is such that the phase is wrapped every 2π.

In this embodiment, the optical element 1 is configured as a transmission lens such that light is incident perpendicularly on the surface 21 of the substrate 2. However, the optical element 1 can also be configured as a reflective lens, a diffraction grating, or a reflective element by arranging the structures 30 in accordance with respective phase distributions.

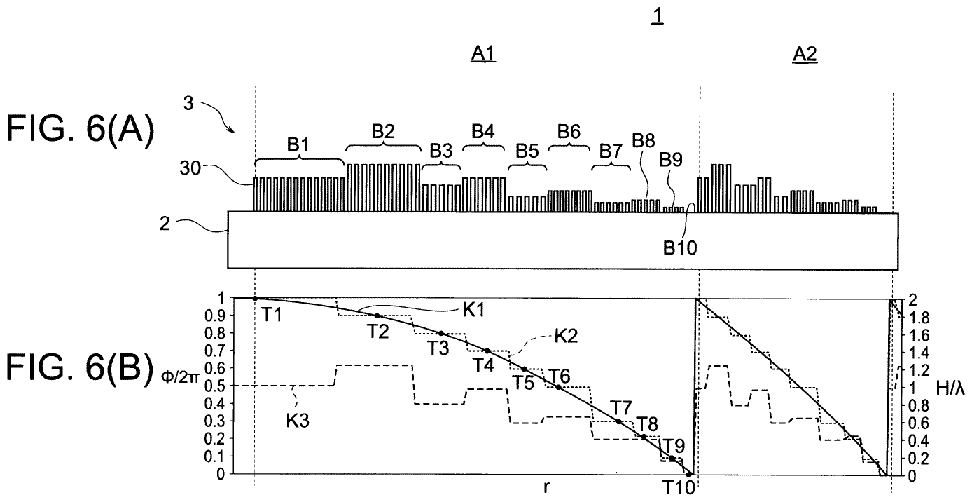

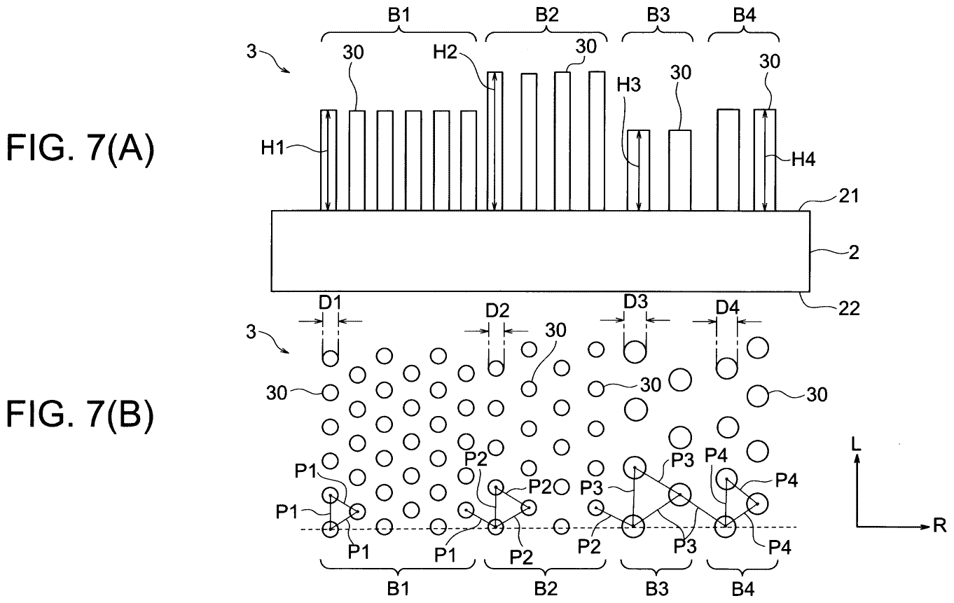

In FIG. 4 and in FIGS. 6(A) and 7(A) described later, bottom portions 32 (FIG. 4) of the structures 30 are positioned on the same plane, and the positions of the top portions 31 (FIG. 4) of the structures 30 are varied. However, this embodiment is not limited to such a configuration, and the top portions 31 of the structures 30 may be positioned on the same plane, and the positions of the bottom portions 32 may be varied.

Next, a configuration example of the microstructure 3 will be described. FIG. 6(A) is a cross-sectional view, taken along the radial direction, schematically showing the structures 30 in the regions B1 to B10 of the ring zones A1 and A2. FIG. 6(B) is a graph showing the phase Q that the structures 30 impart to light in each region B of the ring zones A1 and A2 and the heights H of the structures 30.

In FIG. 6(B), the left vertical axis indicates a value obtained by dividing the phase Φ by 2π, and the right vertical axis indicates a value obtained by dividing the height H by the wavelength λ. The horizontal axis indicates the distance r from the optical axis C.

Each ring zone A is divided into a plurality of regions B, i.e., ten regions B in this example. For example, the ring zone A1 is composed of regions B1, B2, . . . B10. The structure 30 in the first region B1 imparts a phase change of 2π to the light. Moreover, the phase change that the structure 30 in the tenth region B10 impart to the light is 0. In this example, each ring zone A is divided into ten regions B1 to B10, but the number of divisions is not limited to ten.

At least one of the height H, the diameter D and the pitch P of the structure 30 varies for each region B (that is, for each of the regions B1, B2, . . . B10), so that the phase imparted to light is changed. The height H, the pitch P and the diameter D of the structure 30 are also referred to as structure parameters.

By imparting a phase change of at least 0 to 2π to light by the structures 30 in each region B, the optical element 1 can be designed flexibly. Although the structures 30 are configured to impart a phase change of 0 to 2π to the light in this example, the structures 30 may be configured to impart a phase change of more than 2π.

Furthermore, the height H, the diameter D and the pitch P of the structure 30 may be determined so as to suppress (and more preferably, prevent) light reflection at the interface between the structure 30 and air. Thus, the optical element 1 having high transmittance can be obtained without need for forming an anti-reflection film, and cost reduction is made possible.

### (Dimensions and Arrangement of Structures)

The arrangement of the structures 30, as well as the heights H, the pitches P and the diameters D of the structures 30 of the microstructure 3 are determined as follows. In the first step, for example, using FEM (Finite Element Method), the height H, the diameter D and the pitch P are respectively changed within certain ranges, and data on the phase and transmittance is accumulated.

In the second step, an ideal phase distribution, which is indicated by the reference symbol K1 in FIG. 6(B), is determined. This is, for example, the phase distribution of a Fresnel lens that is to be realized by the optical element 1. Based on this ideal phase distribution, discrete values of the phases are determined for each of the regions B1, B2, . . . B10, as indicated by the reference symbol K2. That is, the phases of the regions B1, B2, . . . B10 are determined in such a way that the phase of the region B1 is T1, the phase of the region B2 is T2, . . . , and the like.

In the third step, the heights H, the diameters D and the pitches P (i.e., structural parameters) that provide the discrete phase values T1, T2, . . . T10 obtained in the second step are determined from the phase data accumulated in the first step. For example, for the structure 30 in the region B1, the height H, diameter D and pitch P are determined so as to obtain the phase value T1. The height H determined in this way is H/λ and is indicated by the reference symbol K3 in FIG. 6(B).

Here, the data on the phase and transmittance is accumulated using FEM, and the structural parameters are determined from values obtained by discretizing the ideal phase distribution. However, the structural parameters may also be determined by calculating the phases of the structures 30 in each region through an analysis of the effective refractive index. In this regard, in the case of the structures 30 having diameters smaller than the wavelength of light, it is difficult to determine the phases by analyzing the effective refractive index, and thus it is desirable to use the above-described FEM, RCWA (Rigorous Coupled-Wave Analysis), or the like.

FIGS. 7(A) and 7(B) are a plan view and a side view schematically showing, in an enlarged scale, the regions B1 to B4 of the ring zone A1 in the microstructure 3.

Each structure 30 in the region B1 has a height H1, a diameter D1 and a pitch P1. Each structure 30 in the region B2 has a height H2, a diameter D2 and a pitch P2. Each structure 30 in the region B3 has a height H3, a diameter D3 and a pitch P3. Each structure 30 in the region B4 has a height H4, a diameter D4 and a pitch P4.

At least one of the height H, the diameter D, and the pitch P of the structure 30 may differ between different regions B (for example, the region B1 and the region B2). For example, among two or more different regions B, the diameter D and the pitch P of the structure 30 may be the same and only the height H of the structure 30 may differ.

In the example shown in FIG. 7(B), in each region B, the structures 30 are arranged in a triangular lattice pattern. However, the arrangement of the structures 30 is not limited to such an example, and may be arranged in a square lattice pattern, for example. In this regard, when the structures 30 are arranged in a triangular lattice pattern, the filling rate of the structures 30 can be made higher and the phase change can be made more flexibly, as compared to when the structures 30 are arranged in a square lattice pattern.

As shown in FIG. 7(B), the radial direction of the optical element 1 passing through the center of the optical element 1 (i.e., the optical axis C) is defined as an R direction. Moreover, a circumferential direction about the optical axis C of the optical element 1 is defined as an L direction. The circumferential direction, that is, the L direction, is shown as a straight line for convenience of illustration.

First, one of the structures 30 is disposed at the center of the optical element 1. This structure 30 is referred to as a first structure 30. The first structure 30 is given a height H, a diameter D and a pitch P that provide a phase that is closest to the discrete value of the phase at this position (i.e., the value on the curve K2 shown in FIG. 6(B)) from the stored data described above.

In the example shown in FIG. 7(B), the first structure 30 is included in the region B1, and is therefore given the height H1, the diameter D1, and the pitch P1.

Next, a second structure 30 is placed at a position spaced apart from the first structure 30 by the pitch P1. In the example of FIG. 7 (B), the structures 30 are arranged in a triangular lattice pattern, and thus the second structure 30 is placed at a position spaced apart from the first structure 30 by the pitch P1 in a direction inclined with respect to the R direction by 30 degrees. The second structure 30 is given a height H, a diameter D and a pitch P that provide a phase closest to the discrete value of the phase at this position from the stored data described above.

In the example shown in FIG. 7(B), the second structure 30 is also included in the region B1, and is therefore given the height H1, the diameter D1, and the pitch P1. A plurality of second structures 30 are arranged in the circumferential direction, i.e., the L direction, at an interval of the given pitch P1.

Similarly, a third structure 30 is disposed at a position spaced apart from the second structure 30 by the pitch P1. The third structure 30 is given a height H, a diameter D and a pitch P that provide a phase closest to the discrete value of the phase at this position from the stored data described above. The third structure 30 is disposed at a position spaced apart from the second structure 30 by the pitch P1 in a direction inclined with respect to the R direction by 30 degrees.

In the example shown in FIG. 7(B), the third structure 30 is also included in the region B1, and is therefore given the height H1, the diameter D1, and the pitch P1. A plurality of third structures 30 are arranged in the circumferential direction, i.e., the L direction, at an interval of the given pitch P.

In this manner, all the structures 30 included in the regions B1 to B10 included in the ring zone A1 are arranged and given the heights H, the diameters D and the pitches P (i.e., structural parameters) that provide the phases closest to the discrete values of the phases at their positions. Similarly, for the ring zones A2 to Am, all the structures 30 are arranged and are given the structural parameters. As a result, the microstructure 3 in which the structures 30 are arranged on the substrate 2 is obtained.

In the example shown in FIG. 7(B), the structures 30 are arranged in a triangular lattice pattern, but the structures 30 may be arranged in a square lattice pattern. In such a case, the second structure 30 is disposed at a position spaced apart from the first structure 30 in the R direction by the pitch P1.

### (Manufacturing Process of Optical Element)

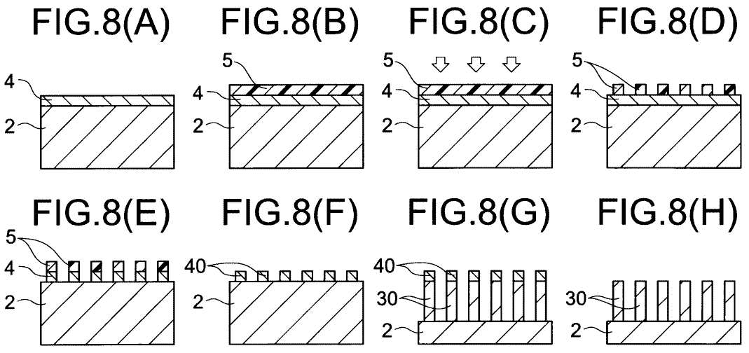

Next, the manufacturing process of the optical element 1 will be described. FIGS. 8(A) to 8(H) are diagrams showing an example of a manufacturing process of the optical element 1. The microstructure 3 can be manufactured, for example, using electron beam lithography technique or deep ultraviolet lithography technique.

First, as shown in FIG. 8(A), the substrate 2 is prepared. The substrate 2 is formed of Si or TiO₂, and the thickness of the substrate 2 is preferably 0.3 mm to 2.0 mm. A metal mask layer 4 is formed on the surface of the substrate 2.

Next, as shown in FIG. 8(B), a resist 5 is coated on the metal mask layer 4.

Next, as shown in FIG. 8(C), the resist 5 is exposed using a mask corresponding to the designed shape of the microstructure 3 including the heights H, the diameters D and the pitches P of the structures 30.

Next, as shown in FIG. 8(D), the resist 5 is developed. If the resist 5 is of a negative type, the exposed portion remains, and if the resist 5 is of a positive type, the exposed portion is removed.

Next, as shown in FIG. 8(E), the metal mask layer 4 is patterned by dry etching or the like using the resist 5, which remains after development, as an etching mask. With this process, the metal layer 40 remains on the resist 5. Thereafter, the resist 5 is removed as shown in FIG. 8(F).

Next, as shown in FIG. 8(G), the substrate 2 is etched using the metal layer 40 on the resist 5 as an etching mask. As a result, the surface of the substrate 2 is patterned, and the structures 30 are formed. Each structure 30 has the height H, the diameter D and the pitch P depending on its position.

Thereafter, as shown in FIG. 8(H), the metal layer 40 is removed. As a result, the microstructure 3 composed of a plurality of structures 30 is formed on the surface of the substrate 2.

As a method for manufacturing the structures 30 having different heights H, it is possible to use, for example, an exposure method using a grayscale mask, a method of drawing while modulating intensity in an electron beam exposure, a method using laser focus scanning, a method of repeating photolithography, or the like.

### (Function)

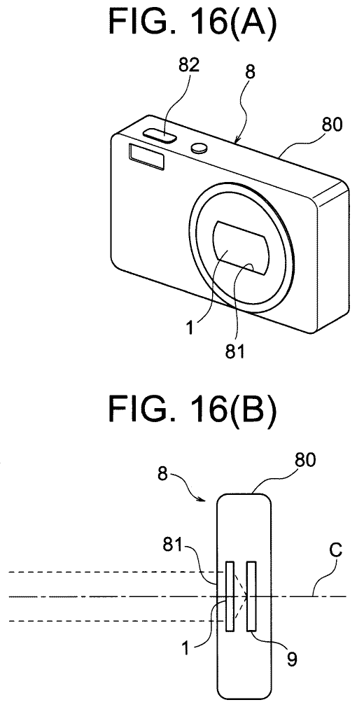

The optical element 1 is used, for example, as a lens of a camera or a sensor which serves as an optical device (see FIGS. 16(A) and 16(B) described later). A camera generally includes a lens group composed of a combination of a plurality of lenses. The lens group can be replaced with the single optical element 1 having the microstructure 3.

In a camera, a lens group may be constructed using a small number of aspherical lenses. In the case of a wide-angle lens, an optical system with a high NA (Numerical Aperture) is required, and the thickness of the lens increases, which increases the manufacturing cost.

Moreover, it is difficult to suppress aberration using a single aspheric lens. For example, when a lens whose NA is 0.7 is used and the diameter of the aperture is set to 12.5 mm, the thickness of the lens is 4.5 mm or more even when the lens is made of Si (silicon) having a high refractive index. When the lens is made of glass having a lower refractive index, the thickness of the lens may be doubled or the lens may have a shape that is difficult to manufacture.

By using the optical element 1 having the microstructure 3, a lens having a thickness of 2.0 mm or less (more preferably 1.0 mm or less) can be manufactured, and the size and weight of the optical device in which the lens is mounted can be reduced.

Furthermore, in order to manufacture a high-performance lens with excellent focusing characteristics, it is necessary to increase the resolution of the phase of light changed by the microstructure 3. In Patent Reference 1, the height and the diameter of the structure are determined to make the phase a desired value. In order to increase the resolution of the phase distribution, it is necessary to precisely control the widths of the structures, and therefore it is necessary to use an exposure apparatus with high resolution.

For example, when an electron beam exposure apparatus or an exposure apparatus using laser scanning is used, it is necessary to make the focal spot smaller in order to increase the resolution. If the focal spot is made smaller, the time required for exposure of the entire lens surface increases, and an expensive exposure apparatus is needed, which increases the manufacturing cost.

In this embodiment, the height H, the diameter D, and the pitch P of the structure 30 are varied. Thus, even if the height H, the diameter D, and the pitch P are controlled relatively roughly, the resolution of the phase of light changed by the microstructure 3 can be increased. Therefore, even if an exposure apparatus with relatively low resolution is used, a high-performance lens can be manufactured.

### (Method of Designing the Structure)

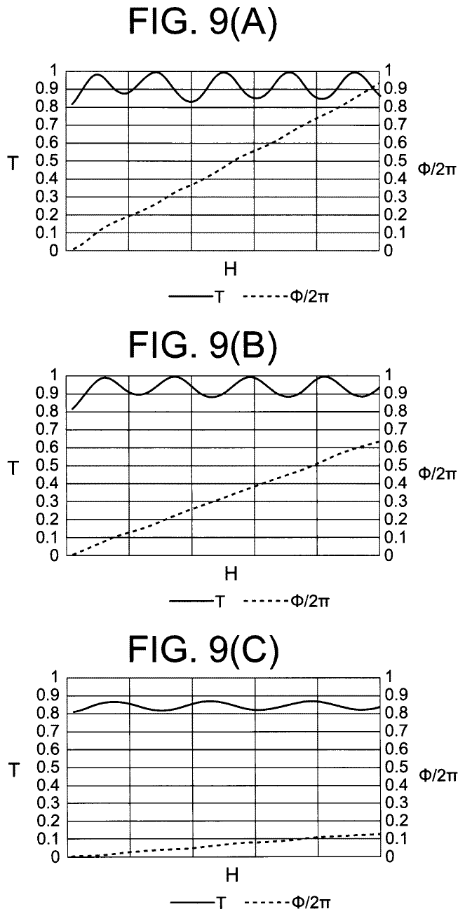

Here, the method of designing the structure 30 using numerical simulation will be described. FIG. 9(A) is a graph showing the change in the transmittance T and the phase difference Φ/2π when the diameter D and the pitch P of the structure 30 are fixed and the height H of the structure 30 is varied. In FIG. 9(A), the left vertical axis indicates the transmittance T, and the right vertical axis indicates the value obtained by dividing the phase difference (by 2n. The horizontal axis indicates the height H of the structure 30.

From the graph of FIG. 9(A), it can be understood that the phase difference Φ increases as the height H of the structure 30 increases. It can also be understood that the transmittance T changes periodically depending on the height H, and therefore there exists a height H at which the transmittance T is high.

FIG. 9(B) is a graph showing the relationship between the height H of the structure 30 and each of the transmittance T and the phase difference Φ/2π when the pitch P is the same as in FIG. 9(A) but the diameter D is smaller than that in FIG. 9(A). FIG. 9(C) is a graph showing the relationship between the height H of the structure 30 and each of the transmittance T and the phase difference Φ/2π when the pitch P is the same as in FIG. 9(A) but the diameter D is further smaller than in FIG. 9(B). In each of FIGS. 9(B) and 9(C), the vertical axes and the horizontal axis are the same as those in FIG. 9(A).

In FIGS. 9(B) and 9(C), the amount of change in the phase difference Φ relative to the change in the height H is smaller than that in FIG. 9(A). Furthermore, although the transmittance T changes periodically with respect to the change in the height H, the transmittance T is generally lower than that in FIG. 9(A).

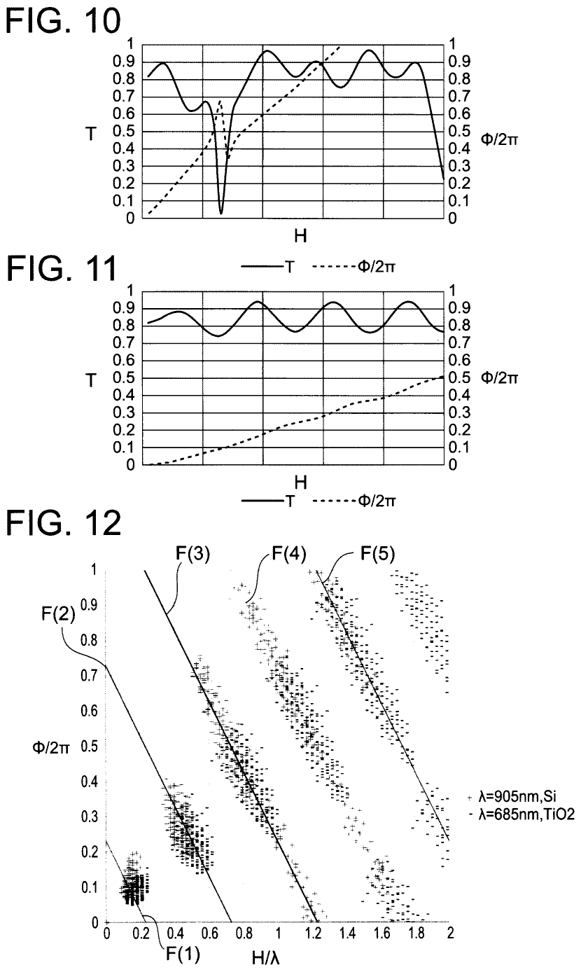

FIG. 10 is a graph showing the relationship between the height H and each of the transmittance T and the phase difference Φ/2π when the pitch P is the same as in FIG. 9(A) but the diameter D is larger than that in FIG. 9(A). The vertical axes and the horizontal axis are the same as those in FIG. 9(A). In FIG. 10, the change in the transmittance T with respect to the change in the height H is not periodic. Further, the transmittance T changes sharply, and there occurs a portion at which the transmittance is 0.1 or less.

FIG. 11 is a graph showing the relationship between the height H and each of the transmittance T and the phase difference Φ/2π when the diameter D is the same as in FIG. 9(A) but the pitch P is larger than that in FIG. 9(A). The vertical axes and the horizontal axis are the same as those in FIG. 9(A). Since the effective refractive index increases as the pitch P increases, the amount of change in the phase difference Φ relative to the change in the height H is smaller as compared to FIG. 9(A).

In order to facilitate the design of the optical element 1, it is desirable to avoid combinations of the diameter D and the pitch P at which the transmittance T changes sharply with a change in the height H (see FIG. 10). By changing the height H at a plurality of combinations of the diameter D and the pitch P, a combination of the height H, the diameter D, and the pitch P at which the transmittance T is high is employed. This makes it possible to change the phase while suppressing reflected light.

FIG. 12 is a graph showing the relationship between the height H of the structure 30 and the phase difference Φ/2π at which the transmittance is 96% or more when the target light wavelength is 685 nm and the optical element 1 is designed using a TiO₂ substrate. The relationship between the height H of the structure 30 and the phase difference θ/(2π) at which the transmittance is 85% or more when the target light wavelength is 905 nm and the optical element 1 is designed using a Si substrate is also shown. The vertical axis of FIG. 12 indicates the value obtained by dividing the phase difference Φ by 2π, and the horizontal axis indicates the value obtained by dividing the height H by the wavelength λ.

In FIG. 12, the data when the light wavelength is 685 nm and the TiO₂ substrate is used is indicated as plots of “+”, and the data when the light wavelength is 905 nm and the Si substrate is used is indicated as plots of “−”. From the plots of “+” and “−” in FIG. 12, it is understood that data when the wavelength of the light is 685 nm and the TiO₂ substrate is used, and data when the wavelength of the light is 905 nm and the Si substrate is used, are both concentrated on the common straight lines F(1) to F(5).

There are a plurality of combinations of the diameter D and the height H at which the transmittance T is high. At the points where the transmittance T periodically increases, the relationship between Φ/2π and H/λ is given by the following Equation (2).

$$\frac{Φ}{2 π} = c - \frac{H}{λ} + 0.5 n ( n = 1 , 2 , 3 … ) \qquad ( 2 )$$

In Equation (2), C is a constant, and c=0.23±1 here. λ is a wavelength of light. The straight lines F(1) to F(5) shown in FIG. 12 correspond to the straight lines obtained when n is changed to 1, 2, 3, 4, and 5 in Equation (2) where c=0.23.

If the ratio of the diameter D to the pitch P (D/P) is too small, the transmittance T is low as shown in FIG. 9(C).

If D/P is too large, the fluctuation in the transmittance T is large as shown in FIG. 10.

Therefore, it is desirable to set the diameter D and pitch P of the structure 30 so as to suppress the decrease in the transmittance T and suppress the fluctuation in the transmittance T. Specifically, for example, when the optical element 1 for a wavelength of 685 nm is manufactured using a TiO₂ substrate, it is desirable to set the diameter D of the structure 30 within a range of 150 nm to 250 nm and the pitch P within a range of 300 nm to 450 nm.

The above-described ranges of the diameter D and the pitch P can be generalized when the optical element 1 is manufactured using the substrate 2 having a refractive index n for light of a wavelength Δ. That is, the refractive index of TiO₂ is expressed as n₀, and the wavelength of light, which is 685 nm, is expressed as λ₀. Further, it is expressed that α=(λ/λ₀)/(n/n₀). The diameter D of the structure 30 is desirably set within the range of α×150 nm to α×250 nm, and the pitch P between the structures 30 is desirably set within the range of α×300 nm to α×450 nm.

Further, α×150 nm, which is the lower limit of the above-described range of the diameter D, can be expressed as 150×(n₀/λ₀)×(λ/n). α×250 nm, which is the upper limit of the range, can be expressed as 250×(n₀/λ₀)×(λ/n). If the wavelength of light is λ₀=685 nm and the refractive index of TiO₂ is n₀=2.58, the range of the diameter D of the structure 30 can be expressed as 0.56×λ/n to 0.95×λ/n. Similarly, the range of the pitch P between the structures 30 can be expressed as 1.1×λ/n to 1.7×λ/n.

Although the diameter D and the pitch P of the structure 30 differ for each region B, the diameter D of the structure 30 is desirably within the range of 0.56×λ/n to 0.95×λ/n and the pitch P of the structure 30 is desirably within the range of 1.1×λ/n to 1.7×λ/n in all of the regions B1 to Bn (FIG. 3).

Although the Equation (2) shows the relationship between the height H/λ and the phase difference Φ/2π of the structure 30, there is a limit in manufacturing. That is, for example, if the ratio of the diameter D to the pitch P of the structure 30 exceeds 0.8 (i.e., D/P>0.8), the proportion of the area of the structure 30 in the surface area of the substrate 2 increases, which increases the aspect ratio and makes etching difficult.

Therefore, the upper limit of the phase difference Φ/2π may be determined based on the phase Φ calculated from the effective refractive index n_{eff} of the structure 30 satisfying D/P=0.8.

The diameters D and the pitches P of the structures 30 may be set at certain intervals (for example, in increments of 10 nm). If the diameter D and the pitch P are set in small intervals, an exposure apparatus with high resolution must be used to manufacture the microstructure 3. In designing the structure 30, the number of combinations of the height H, the diameter D, and the pitch P that must be considered increases, which makes it difficult to obtain the relationship with the phase.

For example, by setting the diameters D and the pitches P in increments of a specified value (for example, in increments of 10 nm), the resolution of the exposure apparatus can be lowered, which reduces the manufacturing cost and facilitates the design of the structures 30. The diameters D and the pitches P may be set in increments of 5 nm or in increments of an integer multiple of 5 nm such as increments of 5 nm, 15 nm or the like. Furthermore, the specific value is not limited to an integer multiple of 5 nm, but may be several nm to several tens of nm. As well as the diameters D and the pitches P, the heights H may be set in increments of a specified value.

The relationship between the phase Φ and the height H of the structure 30 has been described above. The relationship between the phase Φ, the diameter D and the pitch P of the structure 30 will be described below.

The wavelength of the target light is expressed as λ, the refractive index of air is expressed as nₐ, and the effective refractive index of the structure 30 is expressed as n_{eff}. Moreover, the phase at the center position (that is, the optical axis C) of the optical element 1 is expressed as Φ(0). The phase change caused by the structure 30 is expressed by the following Equation (3).

$$Φ = Φ ( 0 ) - {n}_{eff} \times h \times \frac{2 π}{λ} \qquad ( 3 )$$

Here, the effective refractive index n_{eff} is expressed by the following Equation (4), which is a simple approximation, using the refractive index nₐ of air, the refractive index nₛ of the substrate 2 before processing of the microstructure 3 (i.e., the substrate 2 shown in FIG. 8(A)), and the diameter D and the pitch P of the structure 30.

$${n}_{eff} = \sqrt{( \frac{π {D}^{2}}{2 \sqrt{3} {P}^{2}} \times {n}_{s}^{2} ) + ( ( 1 - \frac{2 π {D}^{2}}{2 \sqrt{3} {P}^{2}} ) \times {n}_{a}^{2} )} \qquad ( 4 )$$

If the microstructure 3 is a simple diffraction grating-like structure, the effective refractive index n_{eff} can be well approximated by Equation (4). However, in the case of a structure such as the structure 30 of this embodiment having a smaller diameter P and a lower height H than the wavelength, the actual effective refractive index is smaller than the effective refractive index calculated by Equation (4).

It is known that, when the height of a diffraction grating is h, the effective refractive index n(h)_{eff} of the diffraction grating is expressed by the following Equation (5). n(0)eff is the effective refractive index of a grating whose height is 0. n_{L} is the effective refractive index when the height h of the diffraction grating is regarded as infinite, and is calculated by the above-described Equation (4). (dn(h)²_{eff}/(d(hk)) represents the second derivative of n(h)²_{eff}. By numerically solving this differential equation, the effective refractive index is calculated.

$${n ( h )}_{eff}^{2} = {n ( 0 )}_{eff}^{2} + \frac{2}{π} ( {n}_{L}^{2} - {n ( 0 )}_{eff}^{2} ) arctan ( {π}^{2} \frac{\frac{d {n ( h )}_{eff}^{2}}{d ( h k )}}{{n}_{L}^{2} - {n ( 0 )}_{eff}^{2}} \frac{h}{λ} ) \qquad ( 5 )$$

The height h of the diffraction grating in Equation (5) can be replaced with the height H of the structure 30 of this embodiment.

As the ratio of the diameter D to the pitch P of the structure 30 decreases, the effective refractive index decreases. Therefore, if the height H of the structure 30 is designed using a simple approximation of the effective refractive index as described in prior art Reference 1, the height deviates from the height at which high transmittance is obtained, and the transmittance of the optical element 1 decreases.

The exact effective refractive index can be obtained by using a numerical simulation such as RCWA, FEM, or FDTD (Finite-Difference-Time-Domain) method. The above-described FIGS. 9(A) to 12 show the results of determining the phase Q and the transmittance T when the structural parameters of the structure 30 are changed by a numerical simulation using FEM.

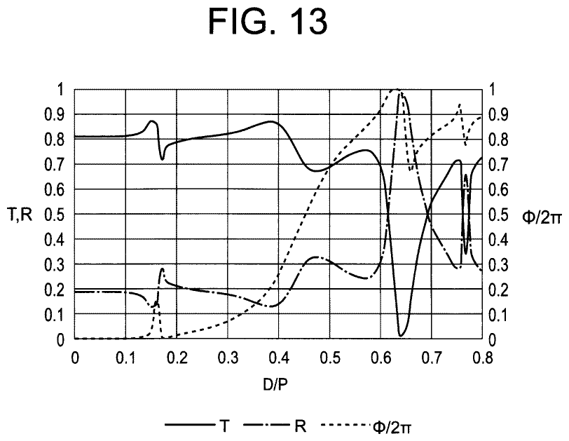

Next, the effect of varying the height H, the diameter D and the pitch P of the structure 30 will be further described. FIG. 13 shows the analysis results of the transmittance T, the reflectance R, and the phase difference Φ/2π when the wavelength of the target light is 685 nm, the optical element 1 is made of TiO₂, and the height H and the pitch P of the structure 30 are fixed and only the diameter D is changed.

In FIG. 13, the left vertical axis indicates the transmittance T and the reflectance R, and the right vertical axis indicates the phase difference Φ/2π. The horizontal axis indicates the value (D/P) obtained by dividing the diameter D by the pitch P.

Due to reflection at the interface between the optical element 1 (here, a lens) and air due to the difference in refractive index, the transmittance of the optical element 1 is generally low and is about 80%. Using the effective refractive index nₛ of the substrate 2 of the optical element 1 and the refractive index nₐ of air, the reflectance R_{F} due to Fresnel reflection at the interface can be expressed by the following Equation (6).

$${R}_{F} = {( \frac{{n}_{s} - {n}_{a}}{{n}_{s} + {n}_{a}} )}^{2} \qquad ( 6 )$$

The reflectance R of the structure 30 is smaller than the reflectance R_{F} due to Fresnel reflection. Further, in FIG. 13, at the resonance point where the transmittance changes sharply, the transmittance is approximately 0%.

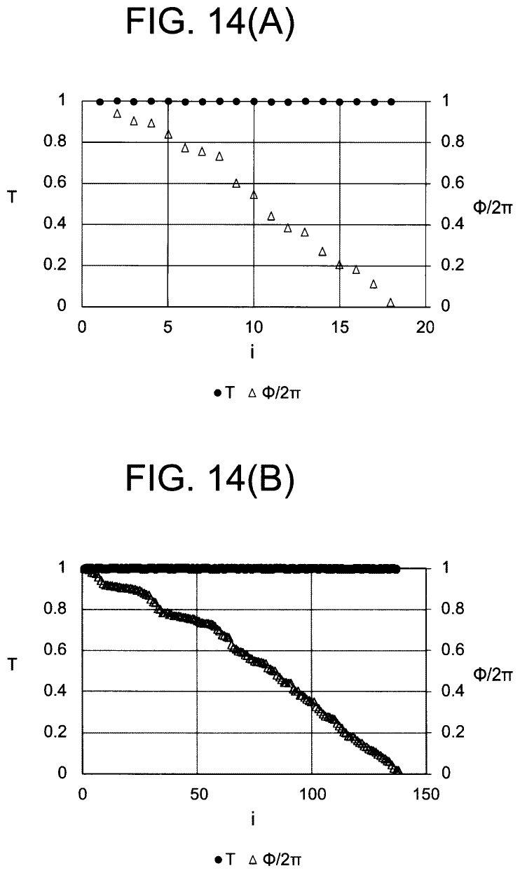

FIG. 14(A) is a graph showing the relationship between the combination of the structural parameters (the height H, the diameter D, and the pitch P) at which the transmittance T is 99.5% or more and each of the transmittance T and the phase difference Φ/2π, when the pitch P is fixed, the diameter D is varied in increments of 10 nm, and the height H is varied in increments of 20 nm. The left vertical axis indicates the transmittance T, the right vertical axis indicates the phase difference Φ/2π, and the horizontal axis indicates the number (set number) “i” identifying the combination.

FIG. 14(B) is a graph showing the relationship between the combination of the structural parameters (the height H, the diameter D, and the pitch P) at which the transmittance T is 99.5% or more and each of the transmittance T and the phase difference Φ/2π, when the diameter D and the pitch P are each varied in increments of 10 nm and the height H is varied in increments of 20 nm. The left vertical axis indicates the transmittance T, the right vertical axis indicates the phase difference Φ/2π, and the horizontal axis indicates the number (set number) “i” identifying the combination.

In FIG. 14(A), since only the height H and the diameter D are varied, the number (i) of combinations of the structural parameters is small, and thus the phase distribution is sparse. Therefore, in FIG. 14(A), there is no combination of the structural parameters at which the phase difference Φ/2π is in the range of 0.6 to 0.7. In other words, lacking of a portion of 0.1 or more occurs in the phase difference Φ/2π. Therefore, the accuracy of the phase distribution that the optical element 1 imparts to the light is low.

In contrast, in FIG. 14(B), the height H, the diameter D, and the pitch P are varied, and thus the number (i) of combinations of the structural parameters is large. Therefore, there are structural parameters corresponding to the phase difference Φ/2π with high accuracy. That is, a smooth phase distribution can be obtained while maintaining high transmittance.

### Effects of First Embodiment

As described above, the optical element 1 of the first embodiment includes the microstructure 3 changing the phase of light on the surface of the substrate 2, and the microstructure 3 includes a plurality of structures 30. The height H, the diameter (i.e., width) D and the pitch (i.e., interval) P of the structure 30 differ depending on the regions B in the microstructure 3. Therefore, the phase distribution can be controlled with high accuracy without increasing the resolution of the exposure apparatus, and the manufacturing cost of the optical element 1 can be reduced.

When the wavelength of light is expressed as A and the refractive index of the substrate 2 is expressed as n, the transmittance of the optical element 1 can be increased and the fluctuation in the transmittance can be suppressed by setting the pitch P between the structures 30 in a range of 1.1×λ/n to 1.7×λ/n.

By setting the diameter D of the structure 30 in a range of 0.56×λ/n to 0.95×λ/n, the transmittance of the optical element 1 can be increased and the fluctuation in the transmittance can be suppressed.

Depending on the regions B in the microstructure 3, the pitches P between the structures 30 are set in increments of specified values (for example, in increments of 10 nm), and the diameters widths D of the structures 30 are set in increments of specified values (for example, in increments of 10 nm). Thus, the phase distribution can be controlled with high accuracy without increasing the resolution of the exposure apparatus.

Since the structure 30 has the height H, the diameter D, and the pitch P that suppress light reflection at the interface between the structure 30 and air, the optical element 1 having high transmittance can be obtained without providing an anti-reflection film or the like. Thus, the manufacturing cost can be further improved.

Since the height H of the structure 30 is determined as expressed by the above-described Equation (2), the optical element 1 having high transmittance can be obtained even if the wavelength of light or the material of the substrate 2 is changed.

In two or more regions among the plurality of regions B of the microstructure 3, the heights H of the structures 30 can be varied while the diameters D and the pitches P of the structures 30 are made the same. This makes it possible to control the phase distribution in the two or more regions B simply by changing the etching depths.

Since the optical element 1 is targeted for light having a wavelength of less than 30 μm, it is possible to obtain the optical element 1 that can be used for visible light and infrared light.

The microstructure 3 is divided into a plurality of concentric ring zones A1 to Am with a phase difference of 2π, and each ring zone A is divided into a plurality of concentric regions B1 to Bn. A plurality of structures 30 included in each region B have the same height H, the same diameter D and the same pitch P. Therefore, it is possible to realize the optical element 1 having the same function as, for example, a Fresnel lens.

Furthermore, since the reflectance of light of the optical element 1 is smaller than the reflectance calculated by Fresnel diffraction from the refractive index n of the substrate 2 and the refractive index of air, it is possible to reduce the reflection and absorption of light at the interface between the optical element 1 and the air.

Furthermore, since the thickness of the optical element 1 is set to 2 mm or less, it becomes possible to mount the optical element 1 on a thin optical device 8. This contributes to reduction in size and weight of the optical device 8.

### Second Embodiment

Next, an optical element 1A of a second embodiment will be described. In the following description, components corresponding to those of the optical element 1 of the first embodiment are assigned with the same reference numerals.

In the microstructure 3 of the optical element 1 of the first embodiment described above, the structures 30 are arranged so as to approximate the ideal phase distribution. In contrast, in the microstructure 3A of the optical element 1A of the second embodiment, the structures 30 are arranged so that the heights of the structures 30 decrease as the phase imparted to light decreases, while approximating the ideal phase distribution.

As described with reference to FIG. 3 in the first embodiment, the microstructure 3A has a plurality of concentric ring zones A1, A2, A3, . . . Am. Each of the ring zones A includes a plurality of concentric regions B1, B2, B3, . . . Bn. Here, the ring zone A is divided into six regions B1 to B6, but the number of divisions is not limited to six and may be any number. In each of the regions B, a plurality of structures 30 are arranged.

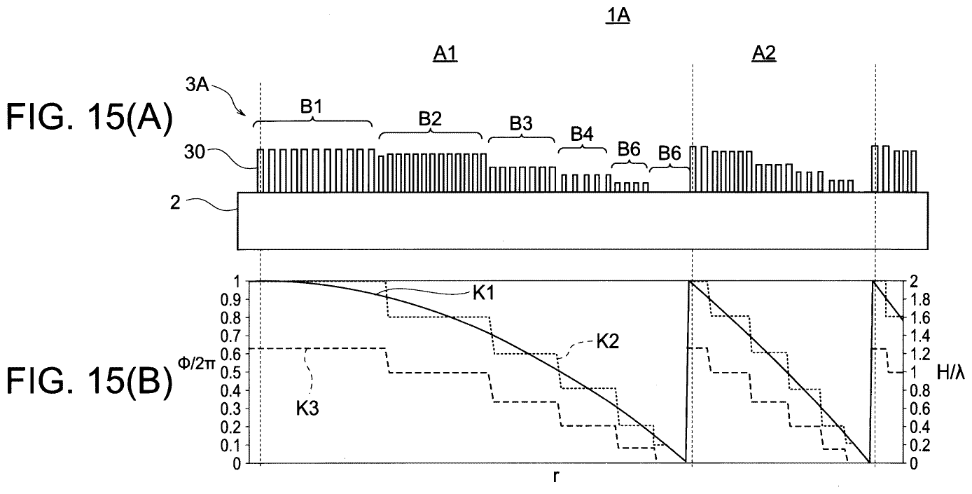

FIG. 15(A) is a cross-sectional view taken along the radial direction, which schematically illustrates the structures 30 in the regions B of the ring zones A1 and A2. FIG. 15(B) is a graph showing the phase Φ that the structures 30 impart to light and the height H of the structures 30 in the regions B of the ring zones A1 and A2. The vertical axes and the horizontal axis are the same as those in FIG. 6(B).

In the microstructure 3A of the second embodiment, the structures 30 in each of the regions B1 to B6 are arranged so that the height H of the structures 30 in each region B is lower than or equal to the height H of the structures 30 in another region B closer to the center (optical axis C) of the optical element 1.

In the example shown in FIGS. 15(A) and 15(B), the height H of the structures 30 in the region B2 is lower than the height H of the structures 30 in the region B1. Moreover, the height H of the structures 30 in the region B3 is lower than the height H of the structures 30 in the region B2. The same applies to the structures 30 in the regions B4 to B6.

The manufacturing process of the optical element 1A of the second embodiment is generally similar to the manufacturing process of the optical element 1 of the first embodiment (FIGS. 8(A) to 8(H)). In the optical element 1A of the second embodiment, sharp change in the heights of the structures 30 is suppressed, and thus processability in the etching step of the substrate 2 (FIG. 8(G)) is improved. Thus, the manufacturing process can be simplified, and the manufacturing cost can be reduced.

In designing the optical element 1A of the second embodiment, as in the first embodiment, the height H, the diameter D and the pitch P of each structure 30 are determined so that the phase in each structure 30 is closest to the discretized value (symbol K2 in FIG. 15(B)) of the ideal phase distribution (symbol K1 in FIG. 15(B)). In the second embodiment, the height H of the structures 30 in each region B is determined to be equal to or lower than the height H of the structures 30 in another region B closer to the center of the optical element 1A than said region B.

Except for the points described above, the optical element 1A of the second embodiment is configured in a similar manner to the optical element 1 of the first embodiment.

As described above, in the optical element 1A of the second embodiment, the height of the structure 30 in each region B of the microstructure 3A is lower than or equal to the height H of the structure 30 in another region B closer to the center of the optical element 1A than said region B, and thus sharp change in the heights of the structures 30 can be suppressed. Thus, the workability in the etching process of the substrate 2 can be improved, and the manufacturing cost can be reduced.

A supplementary explanation will be given regarding the method for analyzing the shapes of the microstructures 3 and 3A (i.e., metasurfaces) of the optical elements 1 and 1A of the first and second embodiments. A method utilizing scattering in a Mie resonator is known as a method for analyzing three-dimensional structures such as spheres or ellipsoids, but this method is difficult to apply to a microstructure having structures of arbitrary shapes (i.e., meta-atoms). As a method for analyzing the microstructures 3 and 3A having complex shapes, electromagnetic field simulation is preferable. Specifically, the above-described FDTD, RCWA and FEM, as well as BPM (Beam Promotion Method) and the like are preferable.

The optical elements 1 and 1A of the first and second embodiments can be applied to an optical device 8 such as an imaging device. For example, FIG. 16(A) is a perspective view showing the external appearance of the optical device 8 including the optical element 1, and FIG. 16(B) is a schematic view showing an internal configuration of the optical device 8. As shown in FIGS. 16(A) and 16(B), the optical element 1 is used as a lens of the optical device 8.

The optical device 8 includes the optical element 1, a light receiving element 9 arranged on the optical axis C of the optical element 1, and a housing 80 that houses these components. An opening 81 is formed on a front surface of the housing 80 so as to face the optical element 1. A switch 82 or the like to be used during imaging is also provided. The optical element 1 forms an image of a subject on the light receiving element 9, and the light receiving element 9 converts the received optical signal into an electrical signal.

A camera generally is provided with a lens group as a combination of a plurality of lenses, but the lens group can be replaced with the optical element 1. The thickness of the optical element 1 is thin, and can be thinned to 2 mm or less, for example, and thus a thin and compact optical device 8 can be realized. The optical device 1 is not limited to a camera, but can also be realized as a sensor or other optical device.

Although the preferred embodiments have been specifically described above, the present disclosure is not limited to the above-described embodiments, and Various improvements and modifications can be made.

### DESCRIPTION OF REFERENCE CHARACTERS

1, 1A: optical element, 2: substrate, 3, 3A: microstructure, 4: metal mask, 5: resist, 8: optical device, 9: light receiving element, 21: surface, 22: back surface, 30: structure, 40: metal layer, A1 to Am: ring zone, B1 to Bn: region, C: optical axis, K1: ideal phase distribution, K2: discretized value of ideal phase distribution.

1. An optical element comprising:
a substrate; and
a microstructure formed on a surface of the substrate, the microstructure changing a phase of light,
wherein the microstructure includes a plurality of zones that impart a phase change of 0 to 2π to the light, each of the plurality of zones being divided into a plurality of regions,
wherein each of the plurality of regions includes a plurality of structures,
wherein each of the plurality of structures has a height in a direction perpendicular to the surface and a width in a direction parallel to the surface, and the plurality of structures are arranged at an interval as a center-to-center distance in the direction parallel to the surface, and
wherein the interval between the plurality of structures arranged in one region of the plurality of regions is different from the interval between the plurality of structures arranged in another region of the plurality of regions.

2. The optical element according to claim 1, wherein when a wavelength of the light is expressed as λ and a refractive index of the substrate is expressed as n, the interval between the structures is 1.1×λ/n or more and 1.7×λ/n or less.

3. The optical element according to claim 1, wherein when the wavelength of the light is expressed as λ and the refractive index of the substrate is expressed as n, the width of the structure is 0.56×λ/n or more and 0.95×λ/n or less.

4. The optical element according to claim 1, wherein in the plurality of regions, the intervals between the structures arranged therein differ in increments of a specified value.

5. The optical element according to claim 1, wherein in the plurality of regions, the heights of the structures arranged therein differ in increments of a specified value.

6. The optical element according to claim 1, wherein the structure has the height, the width and the interval that do not cause reflection of light at an interface between the structure and air.

7. The optical element according to claim 1, wherein the height H of the structure is expressed by the following equation,
$$\frac{Φ}{2 π} = c - \frac{H}{λ} + 0.5 n ( n = 1 , 2 , 3 … )$$
where λ is a wavelength of the light, Φ is a phase of the light, n is an integer, and c is 0.23 which is a constant.

8. The optical element according to claim 1, wherein the microstructure includes two or more regions in which the heights of the structures are different, the widths of the structures are the same, and the intervals of the structures are the same.

9. The optical element according to claim 1, wherein a wavelength of the light is less than 30 μm.

10. The optical element according to claim 1, wherein the plurality of zones are a plurality of concentric ring zones, the plurality of regions are a plurality of concentric regions, and the plurality of structures included in the same regions among the plurality of regions have the same heights, the same widths and the same intervals.

11. The optical element according to claim 10, wherein the height of the structures in each region in the microstructure is equal to or less than the height of the structures in another region closer to the center of the concentric circle than said region.

12. The optical element according to claim 1, wherein a light reflectance of the optical element is smaller than a reflectance calculated by Fresnel diffraction from a refractive index n of the substrate and a refractive index of air.

13. The optical element according to claim 1, wherein the optical element has a thickness of 0.3 mm or more and 2 mm or less.

14. The optical element according to claim 1, wherein the structure is columnar and extends in a direction perpendicular to the surface.

15. An optical device comprising:
the optical element according to claim 1; and
a light receiving element that receives light that passes through the optical element or is reflected by the optical element.

16. The optical element according to claim 1, wherein in the plurality of regions, the widths of the structures differ in increments of a specified value.

17. The optical element according to claim 1, wherein in the plurality of regions, the intervals of the structures arranged therein differ in increments of several nm to several tens of nm.

18. The optical element according to claim 1, wherein in the plurality of regions, the widths of the structures arranged therein differ in increments of several nm to several tens of nm.

19. The optical element according to claim 1, wherein in the plurality of regions, the heights of the structures arranged therein differ in increments of several nm to several tens of nm.
